(19) United States
(12) Patent Application Publication
(10) Pub. No.: US 2010/0131354 A1
(43) Pub. Date: May 27, 2010

(54) METHOD OF EVALUATING ACCEPTABILITY OF DIRECT MAIL ITEMS

(75) Inventors: PETER SHORTALL, WHITE PLAINS, NY (US); RICHARD BALEKDJIAN, Upper Saddle River, NJ (US)

Correspondence Address: HOFFMANN & BARON, LLP, 6900 JERICHO TURNPIKE, SYOSSET, NY, 11791, US

(73) Assignee: MASTERCARD INTERNATIONAL, INC., Purchase, NY (US)

(21) Appl. No.: 12/621,042

(22) Filed: Nov. 18, 2009

Related U.S. Application Data
(60) Provisional application No. 61/115,680, filed on Nov. 18, 2008.

(51) Int. Cl. G06Q 30/00; G06Q 90/00; G06Q 10/00; G06F 3/048

(52) U.S. Cl. 705/14.42; 705/500; 715/764

(57) ABSTRACT

A method is provided herein for evaluating acceptability of direct mail items, the method including preparing an interactive display showing a plurality of mail items. The mail items include one or more direct mail items of interest, with the direct mail items of interest being displayed in similar manner to the other mail items with no additional import being placed on the direct mail items of interest. The method further includes inquiring a plurality of respondents of the interactive display one or more questions as to how the respondents would treat each of the mail items if the respondents had received such mail items in customary fashion. Response dated to the questions is collected to evaluate the acceptability of the direct mail items of interest. Advantageously, with the subject invention, “challenger” direct mailings may be evaluated in a quicker and more thorough fashion than in the prior art.

### CROSS REFERENCE TO RELATED APPLICATION

This application claims priority to U.S. Provisional Patent Application No. 61/115,680, filed on Nov. 18, 2008, the entire contents of which are incorporated by reference herein.

### BACKGROUND OF THE INVENTION

This invention relates to evaluation of credit card direct mailings and, more particularly, to comparative evaluation between candidate direct mailings.

In the prior art, the technique of direct mailing is heavily relied upon in certain industries for obtaining business. The banking and credit card industries, in particular, rely on direct mailings for obtaining new customers or for enlisting existing customers in new programs or offerings.

A direct mailing is mass mailed over a period of time. Various techniques are employed for developing the target set of recipients. The appearance and packaging (e.g. “creative” treatment) of the direct mailings are considered to be critical to consumers' receptiveness in responding to the direct mailings. As such, much consideration is placed into the various items of the direct mailings, including the appearance of the envelope and any inserts, such as a letter, sign-up card, application, leaflet, and so forth.

It has been found that direct mailings may have high response rates, but with a sufficient passage of time, the response rate wanes. As such, distributors of direct mailings are continuously mindful of a direct mailing's performance, i.e., customer response to a direct mailing as shown by enrollment or other participation in the program or offering promoted by the direct mailing.

A successful direct mail package which is in use has been termed a “champion” package in the prior art. To monitor effectiveness of the “champion” package, “challenger” packages are periodically prepared. Limited distributions of the “challenger” packages are made to evaluate the response rate thereto. Typically, in the prior art, once a “challenger” package has a response rate which exceeds the response rate of a “champion” package, the previous “champion” is retired and the “challenger” is adopted as a new “champion” package and used as a direct mailing.

In the prior art, direct mailings are typically conducted by normal mail techniques. Due to delays in the mail, as well as response rates from respondents, the typical process for evaluating “challenger” direct mail packages requires an extensive period of time, normally on the order of several months.

### SUMMARY OF THE INVENTION

In one aspect of the subject invention, a method is provided herein for evaluating the performance of challenger direct mail creative treatments versus champion direct creative treatments, the method including preparing a display showing a plurality of mail items. The mail items include one or more candidate direct mail items and one or more control mail items, with the candidate direct mail items being displayed in similar manner to the control mail items. The method further includes inquiring one or more questions of a plurality of respondents of the display as to how the respondents would treat each of the mail items if the respondents had received the mail items in customary fashion. Response data to the questions is collected to evaluate the acceptability of the candidate direct mail items. Advantageously, with the subject invention, “challenger” direct mailings may be evaluated in a quicker and more thorough fashion than in the prior art.

These and other features of the invention will be better understood through a study of the following detailed description and accompanying drawings.

### BRIEF DESCRIPTION OF THE DRAWINGS

FIG. 1 is a flowchart representing a method according to the subject invention;

FIGS. 2-3 are screenshots of displays useable with the subject invention;

FIGS. 4-7 are screenshots showing questions useable with the subject invention;

FIGS. 8-9 graphically depict direct mail items which are viewable for inspection in according to the subject invention;

FIGS. 10-11 schematically show the direct mail items of FIGS. 8-9 modified to indicate aggregate respondent receptiveness to different aspects of the mail items; and

FIG. 12 is an exemplary system for use with the method of FIG. 1.

### DETAILED DESCRIPTION OF THE INVENTION

A method is provided herein for evaluating candidate direct mail items suitable for use in direct mailings, such as direct mailings through a customary fashion using standard mail techniques (e.g., via the U.S. post office). The direct mail items may be one or more items included in a mailing including, but not limited to: an envelope; a letter insert; and a leaflet. The subject invention may be used to evaluate various characteristics of the direct mail items, including, but not limited to, the appearance and/or the substance contained therein. Inherent in these characteristics may be factors such as color schemes, font size and style, applied emphasis on certain aspects, selection and arrangement of wording, and so forth.

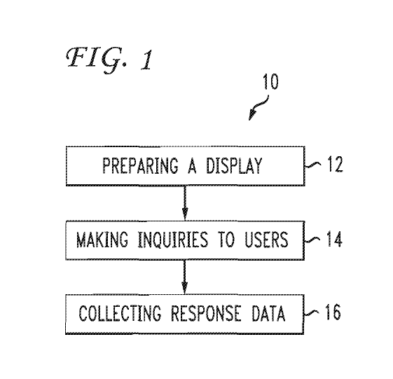

With reference to FIG. 1, the method of the subject invention is generally shown and designated with reference numeral 10. The method 10 includes step 12 of preparing a display, step 14 of making inquiries to the respondents of the display, and step 16 of collecting data based on responses to the inquiries.

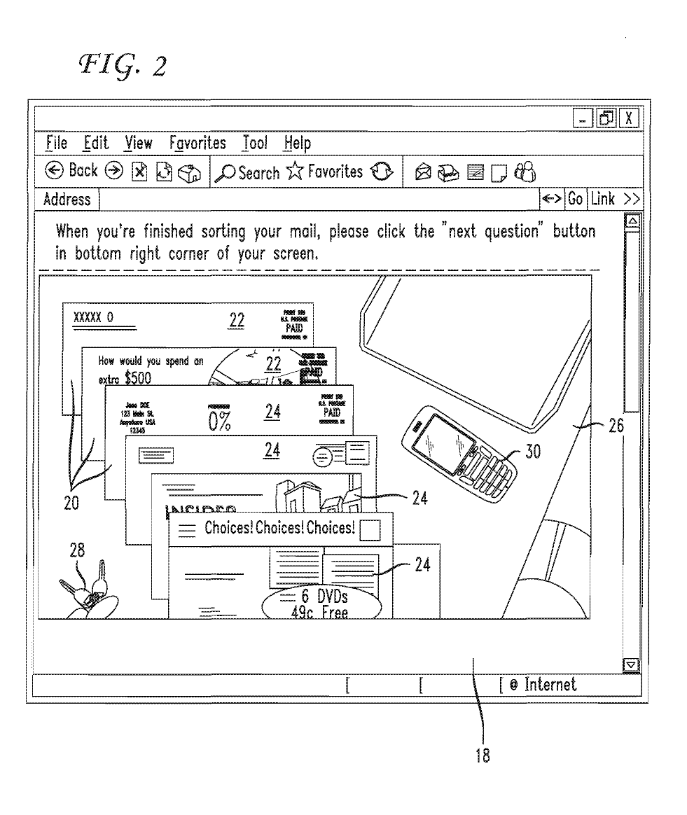

With reference to FIG. 2, a display 18 may be utilized which may be of any known type, particularly, any known type of graphical user interface (GUI), such as an interne browser window. Within the display 18, a plurality of mail items 20 are shown. The mail items 20 preferably include one or more candidate direct mail item 22 and one or more control mail items 24. The candidate direct mail item 22 is a representation of a direct mail item which is of interest and being evaluated. The mail items 20 are preferably shown in a manner similar to how the mail items 20 would be received in customary fashion. For example, the mail items 20 may be shown side by side or stacked as if received as ordinary mail. To enhance this effect, a backdrop 26 may be provided which simulates a desk or kitchen table to graphically represent the mail items 20 as mail received at one's home. Typical home items, such as keys 28 and a cell phone 30, may also be provided to further enhance the effect.

In the step 10 of preparing the display 18, it is preferred that the mail items 20 include a combination of the candidate direct mail items 22 and the control mail items 24. Alternatively, all of the mail items 20 may be the candidate direct mail items 22.

However displayed, it is preferred that all of the mail items 20 be displayed in similar fashion. In this manner, no additional import or emphasis is placed on any of the mail items 20, particularly on the candidate direct mail items 22.

It is preferred that the control mail items 24 resemble typical mail items that one may receive at his home. For example, representations of magazine advertisements, coupon mailers, and so forth may be used. It is preferred that the candidate direct mail items 22 and the control mail items 24 be randomly arranged on the display 18. As shown in FIG. 2, the mail items 20 are preferably arranged in a stacked configuration with sufficient portions of the underlying mail items 20 being shown to permit a respondent to view all of the mail items 20, or at least portions thereof, simultaneously. In this manner, a respondent may select any of the mail items 20 without the mail items 20 being presented individually or in sub-groups in series.

The display 18 may be presented on any suitable device. Examples of suitable devices include computers, television screens, portable media devices, and/or web-enabled devices, such as cellular phones, personal data assistants, etc., that are configured to display text and graphics. The display 18 may be presented to single respondents one at a time (e.g., in a controlled setting) or simultaneously to a plurality of respondents, e.g., over a network (such as a dedicated local area network (LAN), wide area network (WAN), or a publicly-accessible network (Internet)).

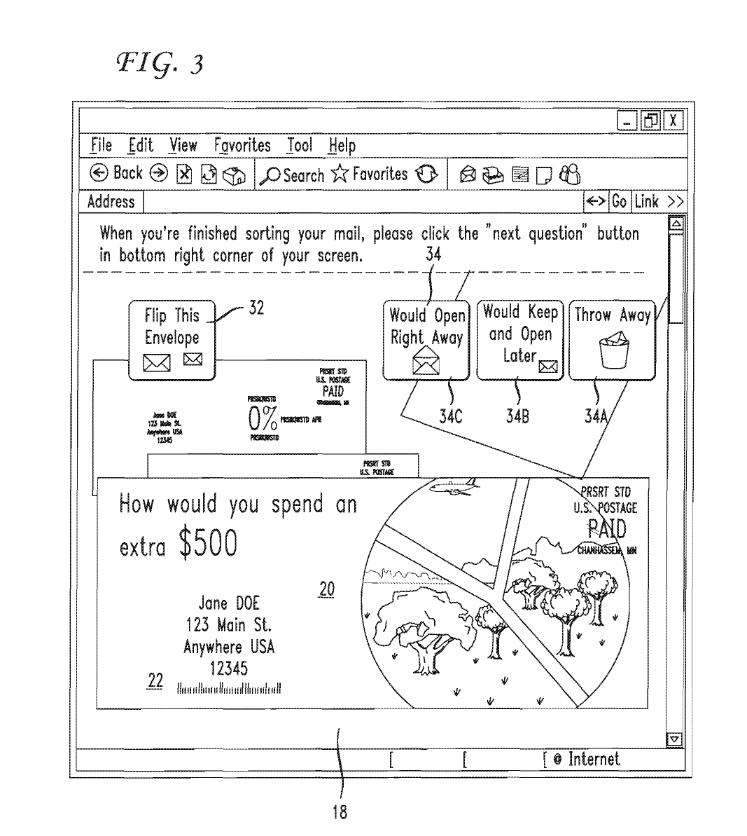

With one or more of the mail items 20 having been presented to respondents, the step 14 of inquiring of respondents may be conducted. With reference to FIG. 3, the inquiring step 14 may be conducted by allowing for selection of one of the mail items 20. As shown in FIG. 3, the selected mail item 20, shown here as one of the candidate direct mail candidates 22, may be enlarged for better viewing. In addition, controls 32 may be provided which allow for viewing of the select mail item 20 from various angles, including the back.

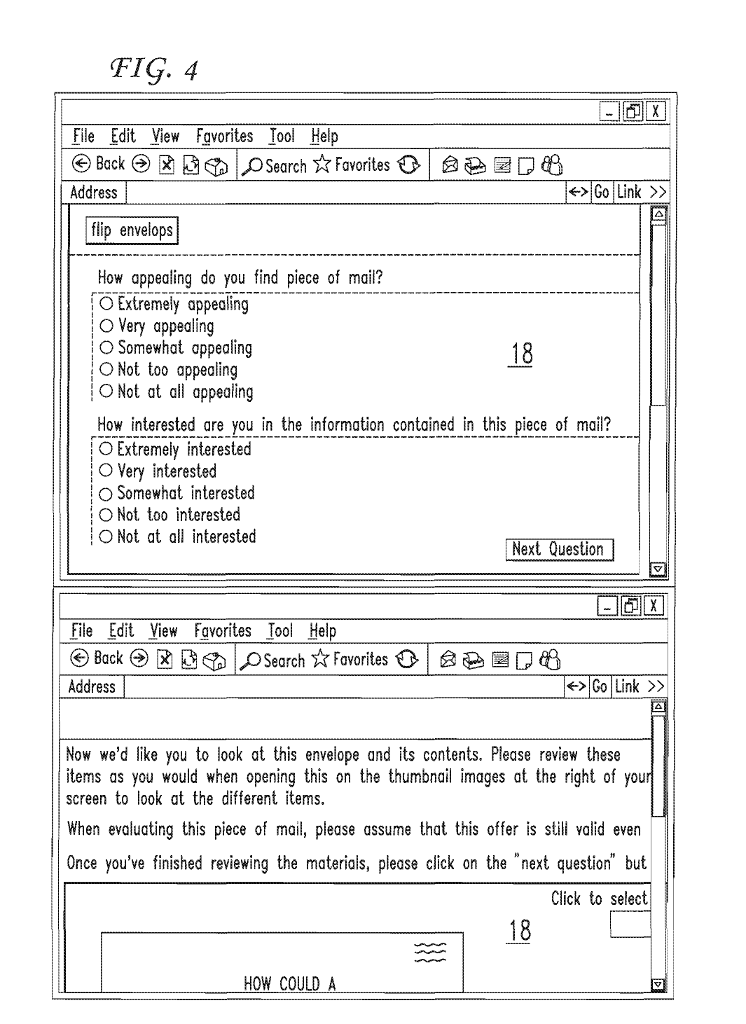

With respect to each of the mail items 20, one or more questions may be posed to a respondent to evaluate the respondent's receptiveness to the mail items 20. Preferably, questions relating to the treatment of the mail items 20 are included. Any manner of delivering these questions to a respondent may be utilized, including the use of interactive buttons 34 which permit a respondent to select an appropriate response. The questions may inquire as to whether or not a respondent would discard the mail item 20 (34A), retain the mail item 20 for later review (34B), and/or would open the mail item 20 immediately (34C). The method 10 allows for the respondent to individually go through the mail items 20 and provide the appropriate response to any of the posed questions, e.g., using the interactive buttons 34. As will be appreciated by those skilled in the art, the step 14 of inquiring is not limited to per se asking questions. Options may be provided which are to be selected. The provision of options or multiple responses may serve as inquiries. With reference to FIG. 4, specific inquiries may also be made.

Response data obtained from answering any posed questions are collected for review and analysis. Based on the responses of respondents, the acceptability of the candidate direct mail items 22 may be evaluated.

As will be appreciated by those skilled in the art, the candidate direct mail items 22 may include direct mail items already in use or had been used (e.g., a champion direct mail) as a control against the candidate direct mail items 22.

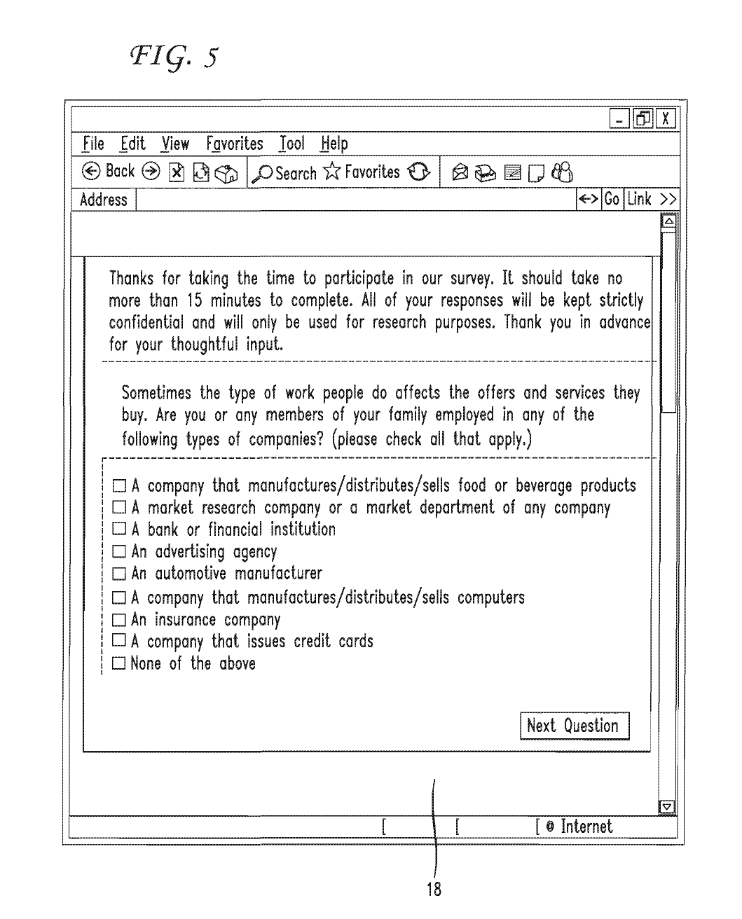

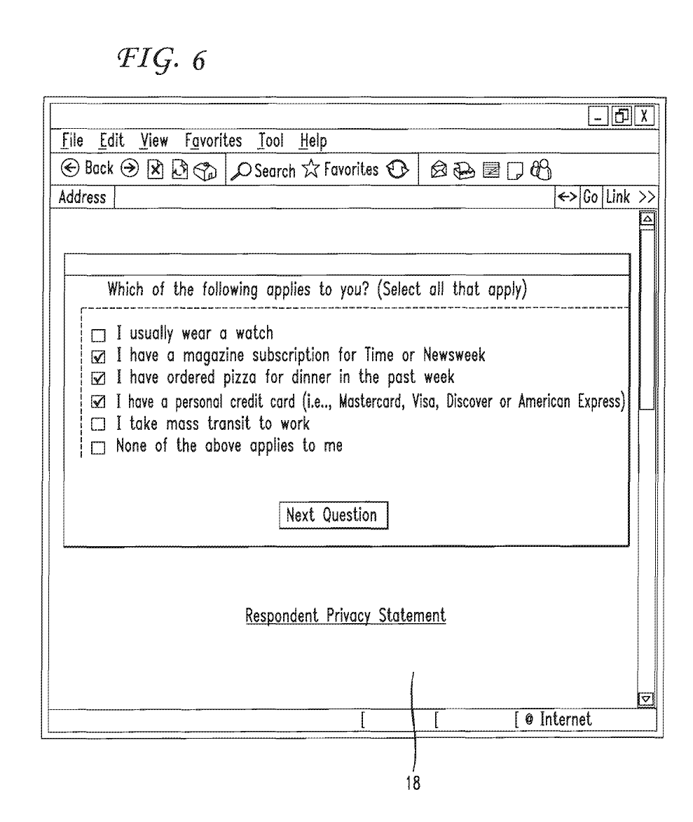

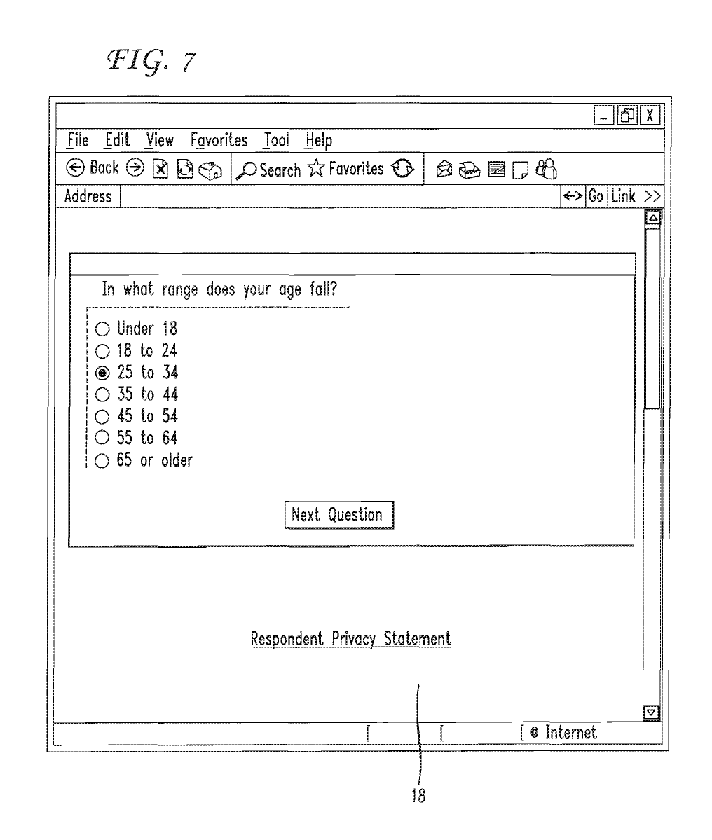

Additional information in support of the analysis of the candidate direct mail items 22 may be obtained by one or more questions being posed of the respondents to obtain personal, lifestyle or other information. With respect to FIGS. 5-7, the age of the respondents may be asked, as well as, other questions of personal nature may be asked that may provide additional information for analysis purposes.

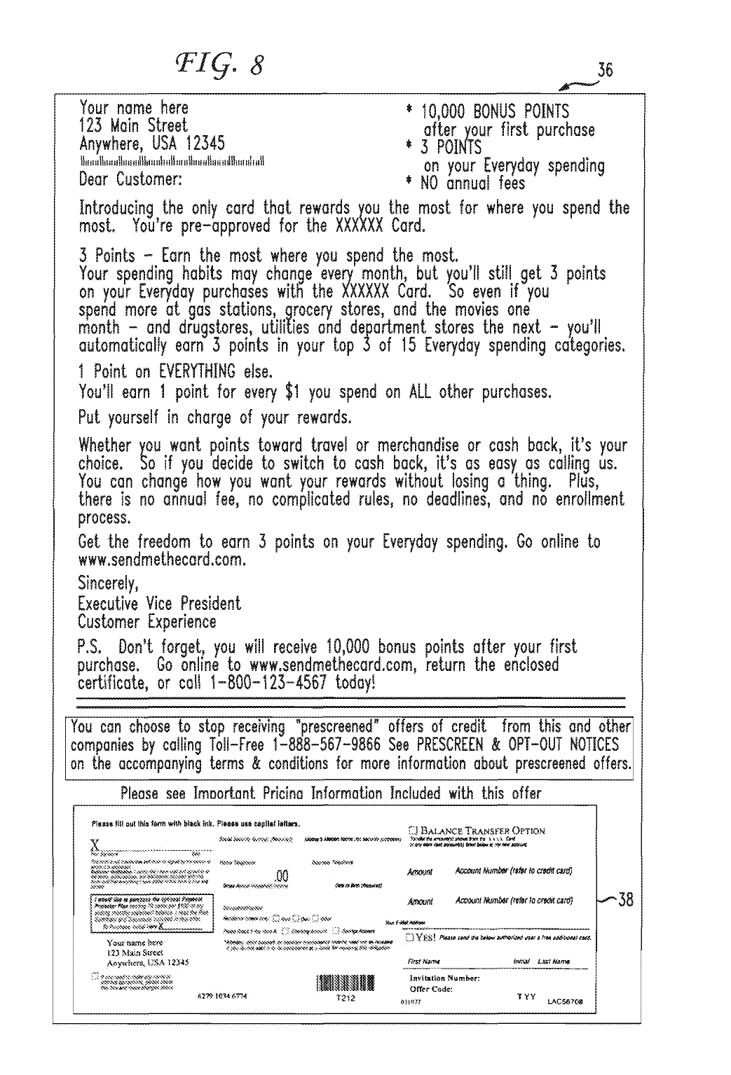

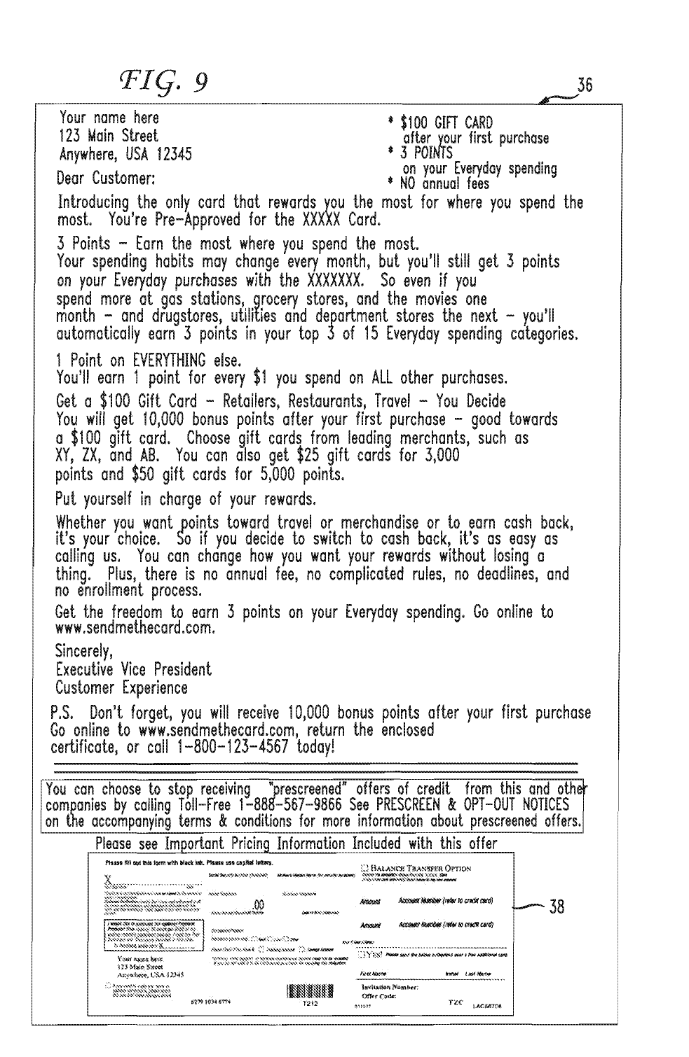

With reference to FIGS. 8-9, the method 10 may further permit the ability to allow for simulated opening of the mail items 20 so as to permit inspection of any intended contents. In particular, the candidate direct mail items 22 may be displayed with all of the contents intended for actual use, including any inserts or items intended for actual use with the candidate direct mail items 22. For example, letters 36 or forms 38 may be graphically represented. Any other mail items may likewise be presented. Questions relating to the contents may be asked to evaluate the acceptability of those contents.

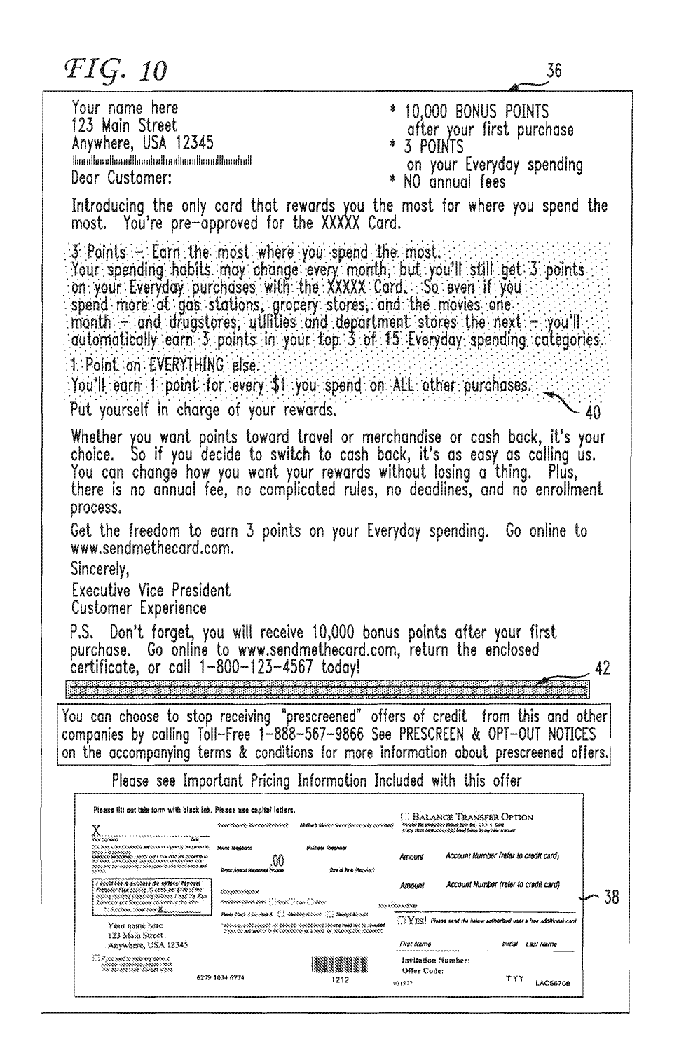

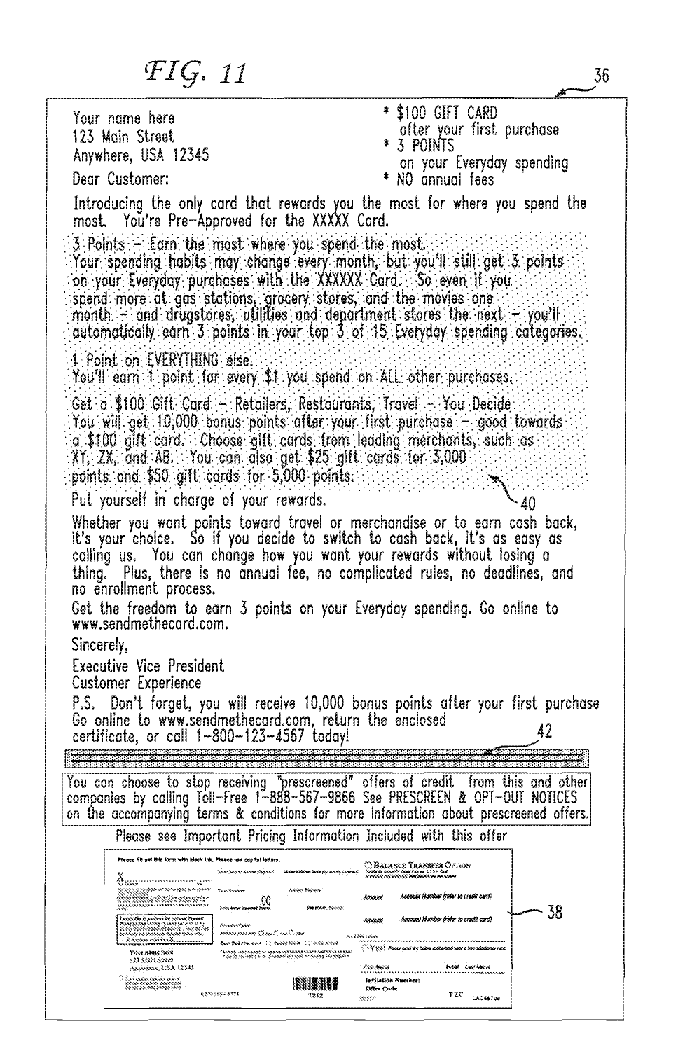

To further gauge acceptability of the candidate direct mail items 22, different respondent interfaces may be provided which allow for a respondent to indicate different levels of acceptance for one or more items of the candidate direct mail items 22. With reference to FIGS. 10-11, by way of non-limiting example, a color or paint application tool may be provided which allows for the respondent to highlight different aspects of the candidate direct mail items 22 with different colors to represent different levels of receptiveness. For example, a respondent may shade an area 40 with a first color (e.g., green) to indicate high likeability, and a second area 42 with a second color (e.g., red) indicating low likeability. As will be appreciated by those skilled in the art, various color and/or graphical ranges and spectrums may be provided to permit different indications of likeability (e.g., the tool may modify the area (e.g., cross-hatching) with or without adding color). Other interface tools may be utilized such as marking or editing tools which permit comments or other graphical indications to be placed onto the candidate direct mail item 22 to represent a respondent's likes or dislikes.

As will be appreciated by those skilled in the art, results and information generated by the method 10 may be produced in various formats for analysis. Individual responses and/or group responses (e.g., reported in aggregate) may be producible. In addition, a plurality of responses for the color or paint application tool may be combined to provide an aggregate result. For example, the coloring may be collectively overlaid to show aggregate response; a more intense coloring may indicate greater or less like or dislike. Other aggregate representations or tabulations may be produced.

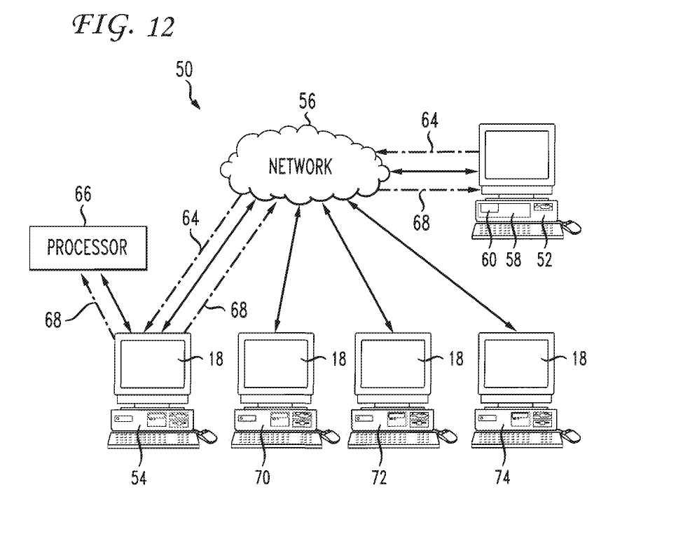

The method 10 may be conducted over various systems or networks, including over the Internet. FIG. 12 provides a non-limiting example of a system 50 for use with the method 10. The system 50 includes a first computing device 52 and a second computing device 54 connected by a network 56. The first computing device 52 having a computer-readable storage medium 58 with a set of instructions 60 that may be transmitted to the second computing device 54 over the network 56. The second computing device 54 providing the display 18 and being configured to receive the set of instructions 60.

The system 50 is configured such that the first computing device transmits an instruction signal 64 to the second computing device 54 over the network 56. The second computing device 54 then receives the instruction signal 64 containing the set of instructions 60, which cause the second computing device 54 to show a plurality of mail items on the display 18. The mail items including the one or more candidate direct mail items 22 and the one or more control mail items 24. The candidate direct mail items 22 being displayed in a manner similar to the control mail items 24. Next, the set of instructions 62 cause the second computing device 54 to inquire for a response for one or more questions via the display 18 as to how the respondent(s) would treat each of the mail items 20, if the respondent(s) had received the mail items 20 in customary fashion. After that, the set of instructions 60 provide for the collection of response data 68 for purposes of evaluating the acceptability of the candidate direct mail items 22. The collected response data 68 may be transmitted to and stored at various locations as will be appreciated by those skilled in the art, such as one or more of a processor 66, the second computing device 54, and/or the first computing device 52.

The processor 66 may be configured to analyze the collected response data and evaluate the acceptability of the candidate direct mail items 22. The processor may be connected to the second computing device 54, with the second computing device 54 transmitting a response signal 68 to the processor 66 to analyze the collected response data. The processor 66 may alternatively be connected to the first computing device 52, in which case the response signal 68 containing the collected data may be transmitted from the second computing device 54 to the first computing device 52 over the network 56 for analysis.

The system 50 of FIG. 12 may include more than two computing devices connected over the network 56. For example, FIG. 12 shows five computing devices 52, 54, 70, 72, 74 connected over the network 56. As will be appreciated by those skilled in the art, the system may be configured such that the steps of the method 10 may be conducted on one or more computing devices, which may provide for the use of a plurality of computing devices simultaneously (e.g., the display 18 may be presented to single respondents one at a time (e.g., in a controlled setting) or simultaneously to a plurality of respondents).

Moreover, the computing devices may include combinations of various types of suitable devices. For example, the types of suitable computing devices connected over the network may include the first computing device 52 being a server or a computer and the second computing device 54 being a computer, a television, a personal media player, or a web-enabled device, such as a cellular phone, a personal data assistant, etc.

Furthermore, the system 50 may be run over various types of networks 56. For example, a dedicated local area network (LAN), wide area network (WAN), or a publicly-accessible network (Internet).

Interaction with the display 18 may be accomplished via known mechanisms, including through any of a keyboard, mouse, touch screen, stylus and so forth.

With the method 10 of the subject invention, the candidate direct mail items 22 may be presented to a population of respondents using electronic transmission. As such, delays with ordinary mail can be avoided. The selected population of respondents may be random and/or predetermined. Once the display 18 is made available to the respondents, data can be collected relatively quickly. In this manner, the candidate direct mail items 22 may be evaluated based on the response data.

What is claimed is:

1. A method of evaluating acceptability of direct mail items, said method comprising:
preparing a display showing a plurality of mail items, said mail items including one or more candidate direct mail items and one or more control mail items, said candidate direct mail items being displayed in similar manner to said control mail items;
inquiring one or more questions of a plurality of respondents of said display as to how the respondents would treat each of said mail items if the respondents had received said mail items in customary fashion; and,
collecting response data to said questions to evaluate the acceptability of said candidate direct mail items.

2. A method as in claim 1, wherein said inquiring includes inquiring one or more questions as to whether the respondents would discard one or more of said mail items.

3. A method as in claim 1, wherein said inquiring includes inquiring one or more questions as to whether the respondents would set aside one or more of the mail items for later review.

4. A method as in claim 1, wherein said inquiring includes inquiring one or more questions as to whether the respondents would immediately read one or more of the mail items.

5. A method as in claim 1, wherein said candidate direct mail items are displayed simultaneously with said control mail items.

6. A method as in claim 1, wherein said display is interactive.

7. A system for evaluating acceptability of direct mail items, said system comprising:
a first computing device having a computer-readable storage medium with a set of instructions;
a second computing device having a display; and
a network operatively connecting said first and second computing devices;
wherein said first computing device transmits said set of instructions to said second computing device and said second computing device receives said set of instruction, said set of instructions configured to:
show a plurality of mail items on said display, said mail items including one or more candidate direct mail items and one or more control mail items, said candidate direct mail items being displayed in similar manner to said control mail items;
inquire for a response for one or more questions of a plurality of respondents of said display as to how the respondents would treat each of said mail items if the respondents had received said mail items in customary fashion; and
collect response data to said questions to evaluate the acceptability of said candidate direct mail items.

8. The system of claim 7, further comprising a processor, said processor configured to analyze said collected response data and evaluate the acceptability of said candidate direct mail items.

9. The system of claim 8, wherein said second computing device further includes said processor, wherein said processor receives the collected response data and said processor analyzes the collected response data on said second computing device.

10. The system of claim 8, wherein said first computing device further includes said processor, wherein said first computing device receives the collected response data and said processor analyzes the collected response data on said first computing device.

11. The system of claim 7, wherein said display is interactive.

12. The system of claim 7, wherein said first computing device transmits said set of instructions to at least two computing devices.

13. The system of claim 7, wherein said set of instructions are transmitted from at least two computing devices.

14. A computer-readable storage medium comprising instructions that when executed by a processor causes said processor to:
show a plurality of mail items on a display, said mail items including one or more candidate direct mail items and one or more control mail items, said candidate direct mail items being displayed in similar manner to said control mail items;
inquire a response for one or more questions of a plurality of respondents of said display as to how the respondents would treat each of said mail items if the respondents had received said mail items in customary fashion; and,
collect response data to said questions to evaluate the acceptability of said candidate direct mail items.
